(19) United States
(12) Patent Application Publication
(10) Pub. No.: US 2019/0249751 A1
(43) Pub. Date: Aug. 15, 2019

(54) SPEED REDUCER, MOTOR UNIT, AND CLEANING ROBOT

(71) Applicant: Nidec Corporation, Kyoto (JP)

(72) Inventors: Kenta MIYOSHI, Kyoto (JP); Satoshi UEDA, Kyoto (JP)

(21) Appl. No.: 16/263,132

(22) Filed: Jan. 31, 2019

(30) Foreign Application Priority Data
Feb. 15, 2018 (JP) 2018-025051

(51) Int. Cl. F16H 1/08; A47L 11/40; F16H 57/023

(52) U.S. Cl. CPC F16H 1/08; F16B 43/00; F16H 57/023; A47L 11/4063

(57) ABSTRACT

A speed reducer includes a helical gear body including helical gears, a rotating shaft, a shaft holder, and a first washer disposed around the rotating shaft between the helical gear body and the shaft holder. The helical gears are disposed coaxially, are capable of rotating around the center axis, and have the same torsion angle. The shaft holder is opposed to an axial-direction end portion of the helical gear body in an axial direction via the first washer. At least one of a radially inner end portion and a radially outer end portion of the first washer includes a washer contact surface. One of the axial-direction end portion of the helical gear body and the shaft holder includes an opposed surface opposed to the washer contact surface at least in a circumferential direction.

### CROSS REFERENCE TO RELATED APPLICATIONS

This application claims the benefit of priority to Japanese Patent Application No. 2018-025051 filed on Feb. 15, 2018. The entire contents of this application are hereby incorporated herein by reference.

### BACKGROUND OF THE INVENTION

### 1. Field of the Invention

The present disclosure relates to a speed reducer, a motor unit, and a cleaning robot.

### 2. Description of the Related Art

A speed reducer of a motor unit generally uses a large number of gears. For example, Japanese Laid-open Patent Application Publication 2017-77088 discloses a motor unit in which a motor, an output shaft, and multiple spur gears that transmit rotation of the motor to the output shaft are housed in a casing.

In this connection, a helical gear is more suitable than the spur gear in order to uniformly transmit larger torque. The helical gear can transmit larger torque as a torsion angle is increased.

However, a force in an axial direction acts on the helical gear because the helical gear meshes with another gear. The force acting in the axial direction further increases as the torsion angle of the helical gear is increased. Therefore, when a helical gear rotates while meshing with another gear, the end face of the helical gear may hit, for example, a shaft holding member and wear.

### SUMMARY OF THE INVENTION

An illustrative speed reducer of the present disclosure transmits torque of a motor to an output shaft. The speed reducer includes a helical gear body including a plurality of helical gears that have different diameters and are an integral structure; a rotating shaft that extends in an up-down direction of a center axis and supports the helical gear body; a shaft holder that holds the rotating shaft; and a first washer disposed around the rotating shaft between the helical gear body and the shaft holder. The plurality of helical gears are disposed coaxially, are capable of rotating around the center axis, and have a same torsion angle. The shaft holder is opposed to an axial-direction end portion of the helical gear body in an axial direction via the first washer. At least one of a radially inner end portion and a radially outer end portion of the first washer includes a washer contact surface, a radial-direction distance of which from the center axis is different depending on a circumferential-direction position. One of the axial-direction end portion of the helical gear body and the shaft holder includes an opposed surface that is opposed to the washer contact surface at least in a circumferential direction.

An illustrative motor unit of the present disclosure includes a motor and the speed reducer that is attached to the motor and transmits torque of the motor to an output shaft.

An illustrative cleaning robot of the present disclosure is provided with the motor unit.

With the illustrative speed reducer, the illustrative motor unit, and the illustrative cleaning robot of the present disclosure, it is possible to prevent wear of an end surface of a helical gear body.

The above and other elements, features, steps, characteristics and advantages of the present discloser will become more apparent from the following detailed description of the preferred embodiments with reference to the attached drawings.

### BRIEF DESCRIPTION OF THE DRAWINGS

FIG. 1 is a block diagram of a cleaning robot.

FIG. 2A is a perspective view of a motor unit.

FIG. 2B is a top view of the motor unit.

FIG. 3 is an exploded perspective view for explaining a supporting mechanism of a helical gear body.

FIG. 4 is a sectional view illustrating an example of the supporting mechanism of the helical gear body.

FIG. 5 is a sectional view illustrating another example of the supporting mechanism of the helical gear body.

FIG. 6A is a top view illustrating a first example of a first washer.

FIG. 6B is a top view illustrating a second example of the first washer.

FIG. 6C is a top view illustrating a third example of the first washer.

FIG. 6D is a top view illustrating a fourth example of the first washer.

FIG. 6E is a top view illustrating a fifth example of the first washer.

### DETAILED DESCRIPTION OF THE PREFERRED EMBODIMENTS

Illustrative embodiments of the present disclosure are explained below with reference to the drawings.

In this specification, a rotation axis of a helical gear body 3 explained below is referred to as “center axis CA” and an up-down direction in which the center axis CA extends is referred to as “axial direction”. In the axial direction, a side a direction from a shaft holding section 12 explained below toward the helical gear body 3 is defined as an axial-direction one side, which is referred to as “an axially upper side”, and a side in a direction from the helical gear body 3 toward the shaft holding section 12 is defined as an axial-direction other side, which is referred to as “axially lower side”. In each component, an end portion on the axially upper side is referred to as “axially upper end portion” and a position of the end portion on the axially upper side is referred to as “axially upper end”. Further, an end portion on the axially lower side is referred to as “axially lower end portion” and a position of the end portion on the axially lower side is referred to as “axially lower end”. In the surfaces of each component, the surface facing the axially upper side is referred to as “upper surface” and a surface facing the axially lower side is referred to as “lower surface”.

Further, a direction orthogonal to the center axis CA is referred to as “radial direction” and a rotating direction around the center axis CA is referred to as “circumferential direction”. In the radial direction, a side in a direction closer to the center axis CA is referred to as “radially inner side” and a side in a direction farther from the center axis CA is referred to as “radially outer side”. In each component, an end portion on the radially inner side is referred to as “radially inner end portion” and a position of the end portion on the radially inner side is referred to as “radially inner end”. Further, an end portion on the radially outer side is referred to as “radially outer end portion” and a position of the end portion on the radially outer side is referred to as “radially outer end”. In side surfaces of each component, a side surface facing the radially inner side is referred to as “radially inner side surface” and a side surface facing the radially outer side is referred to as “radially outer side surface”.

The appellations such as the directions, the end portions, the positions of the end portions, and the surfaces explained above do not indicate positional relations, directions, and the like in the case in which the components are actually incorporated in an apparatus.

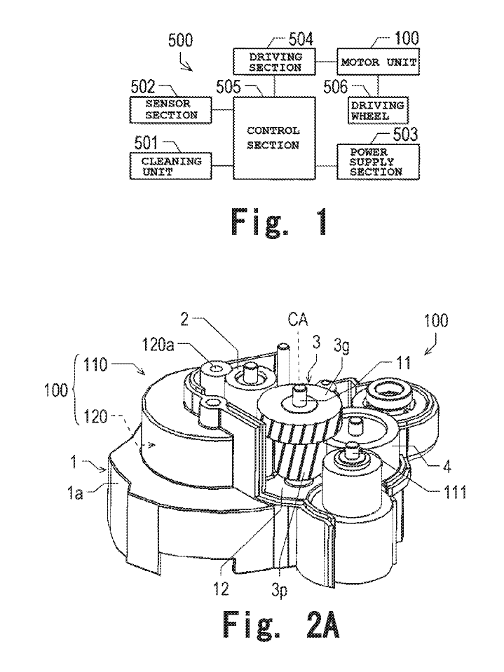

A cleaning robot 500 is, for example, a self-propelled electric cleaning apparatus that autonomously travels on a floor surface and cleans the floor surface. FIG. 1 is a block diagram of the cleaning robot 500. The cleaning robot 500 includes a cleaning unit 501, a sensor section 502, a power supply section 503, a driving section 504, and a control section 505. The cleaning robot 500 is mounted with a motor unit 100. The cleaning unit 501 generates a negative pressure through driving to collect dust from a suction port and catches the dust. The sensor section 502 is, for example, an infrared sensor and detects obstacles such as a wall and furniture, a step, and the like. The power supply section 503 is, for example, a secondary battery and supplies electric power to the components of the cleaning robot 500. The driving section 504 controls driving of the motor unit 100. The control section 505 controls the components of the cleaning robot 500. In this embodiment, the motor unit 100 is a driving device that drives a driving wheel 506. The driving wheel 506 is a wheel for causing the cleaning robot 500 to travel in conjunction with a driven wheel (not illustrated in FIG. 1). It is possible to provide the cleaning robot 500 further reduced in size at low cost by mounting the motor unit 100 in this embodiment. However, uses of the motor unit 100 are not limited to the above illustration.

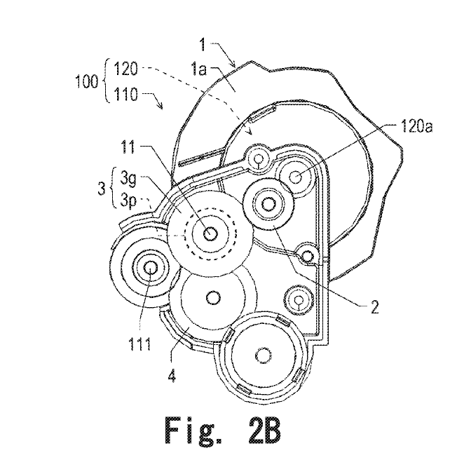

FIG. 2A is a perspective view of the motor unit 100. FIG. 2B is a top view of the motor unit 100. In FIGS. 2A and 2B, illustration of an upper casing 1b explained below is omitted to facilitate understanding of the configuration.

The motor unit 100 includes, as illustrated in FIGS. 2A and 2B, a speed reducer 110 and a motor 120. The speed reducer 110 is attached to the motor 120 and transmits torque of the motor 120 to an output shaft 111. The motor 120 is controlled to be driven by the driving section 504. More specifically, the speed reducer 110 converts torque transmitted from a shaft 120a of the motor 120 into torque of a predetermined reduction ratio and transmits the torque to the output shaft 111. The torque transmitted to the output shaft 111 serves as a driving force for the driving wheel 506 of the cleaning robot 500. Since the motor unit 100 includes the speed reducer 110 in this embodiment, the motor unit 100 can efficiently transmit the torque of the motor 120 to the output shaft 111 at low cost.

The configuration of the speed reducer 110 is explained below. The speed reducer 110 includes, as illustrated in FIGS. 2A and 2B, a casing 1, a first transmission gear 2, a helical gear body 3, and a second transmission gear 4. The speed reducer 110 further includes a stopper 5, a first washer 6, and a second washer 7. The stopper 5, the first washer 6, and the second washer 7 are explained below.

The casing 1 houses the motor 120 and rotatably supports a gear group including the first transmission gear 2, the helical gear body 3, and the second transmission gear 4. More specifically, the casing 1 includes a lower casing 1a and an upper casing 1b. The lower casing 1a includes: a rotating shaft section 11 that extends in the up-down direction of the center axis CA and supports the helical gear body 3; other rotating shaft sections that extend in the axial direction and respectively rotatably support the gear group other than the helical gear body 3; and a shaft holding section 12 that holds the rotating shaft sections including the rotating shaft section 11. In other words, the speed reducer 110 includes the multiple rotating shaft sections including the rotating shaft section 11 and the shaft holding section 12. The shaft holding section 12 is opposed to the axially lower end portion of the helical gear body 3 via the first washer 6 and the second washer 7. The upper casing 1b is attached to the axially upper side of the lower casing 1a. The upper casing 1b supports the axially upper end portions of the rotating shaft sections including the rotating shaft section 11.

The helical gear body 3 is capable of rotating around the center axis CA and includes multiple helical gears having different diameters (in other words, radially outer diameters). In this embodiment, the multiple helical gears 3g and 3p include a first helical gear 3g and a second helical gear 3p. That is, the helical gear body 3 includes the first helical gear 3g and the second helical gear 3p. The diameter of the first helical gear 3g is larger than the diameter of the second helical gear 3p. The helical gear body 3 may be configured to include three or more helical gears without being limited to the illustration of this embodiment. The supporting mechanism of the helical gear body 3 is explained below.

The first transmission gear 2 is a helical gear capable of rotating around a rotation axis extending in the axial direction. The first transmission gear 2 is opposed to a helical gear provided in the shaft 120a in the radial direction and meshes with the helical gear. Further, the first transmission gear 2 is opposed to the first helical gear 3g in the radial direction and meshes with the first helical gear 3g and transmits torque from the motor 120 to the first helical gear 3g. In this embodiment, the first transmission gear 2 is an idle gear. Torque is transmitted from the shaft 120a to the first transmission gear 2 at a reduction ratio corresponding to a gear ratio of the gear provided in the shaft 120a and the first transmission gear 2. The first transmission gear 2 transmits the torque to the helical gear body 3 at a reduction ratio corresponding to a gear ratio of the first transmission gear 2 and the first helical gear 3g.

When viewed from the axial direction, the first transmission gear 2 desirably at least partially overlaps the motor 120. In this embodiment, as illustrated in FIG. 2B, when viewed from the axial direction, the entire first transmission gear 2 is located on the motor 120. A helical gear can be formed thinner than a spur gear. For this reason, even if the first transmission gear 2 is located on the motor 120 in the axial direction, the configuration explained above enables size reduction of the motor unit 100 without greatly increasing the axial-direction dimension of the speed reducer 110.

The second transmission gear 4 is a helical gear capable of rotating around a rotation axis extending in the axial direction. The second transmission gear 4 is opposed to the second helical gear 3p in the radial direction and meshes with the second helical gear 3p. Further, the second transmission gear 4 is opposed to a helical gear provided in the output shaft 111 in the radial direction and meshes with the helical gear and transmits torque from the second helical gear 3p to the output shaft 111. In this embodiment, the second transmission gear 4 is an idle gear. The second transmission gear 4 transmits torque, which is transmitted to the helical gear body 3, to the output shaft 111 at a reduction ratio corresponding to a gear ratio of the second helical gear 3p and the helical gear provided in the output shaft 111.

Torque of the motor 120 is transmitted to the output shaft 111 at reduction ratios corresponding to gear ratios of gears that mesh with one another. More specifically, first, the torque of the motor 120 is transmitted from the gear provided in the shaft 120a to the first helical gear 3g of the helical gear body 3 through the first transmission gear 2. The torque transmitted to the helical gear body 3 is transmitted from the second helical gear 3p to the output shaft 111 through the second transmission gear 4.

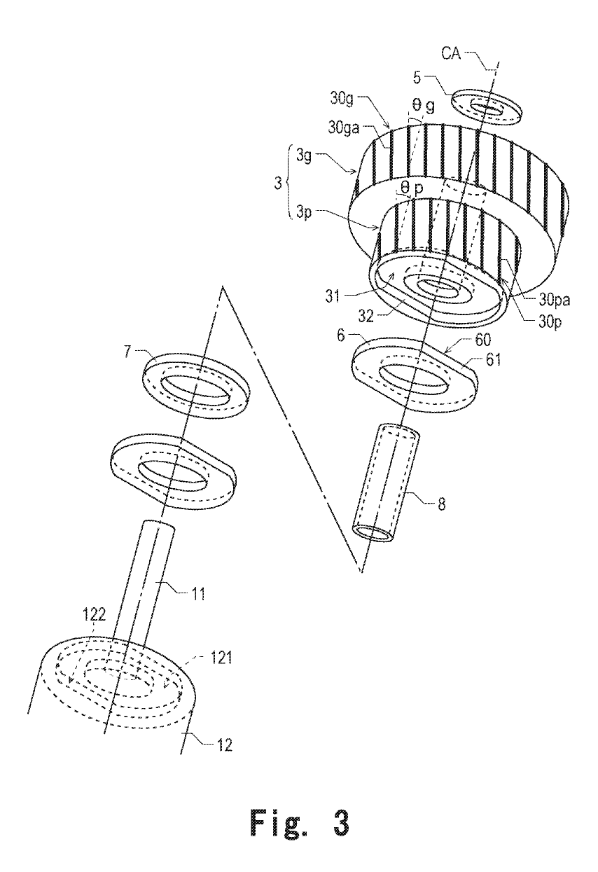

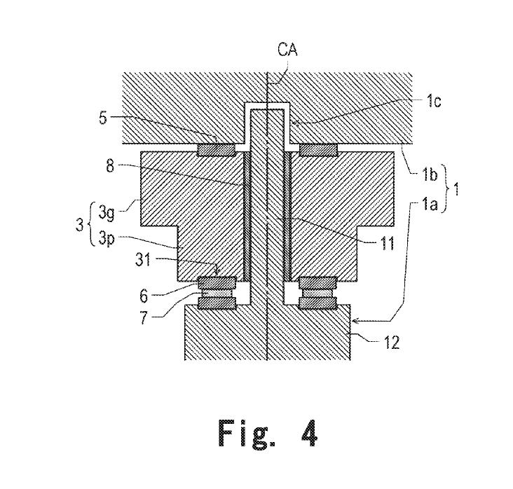

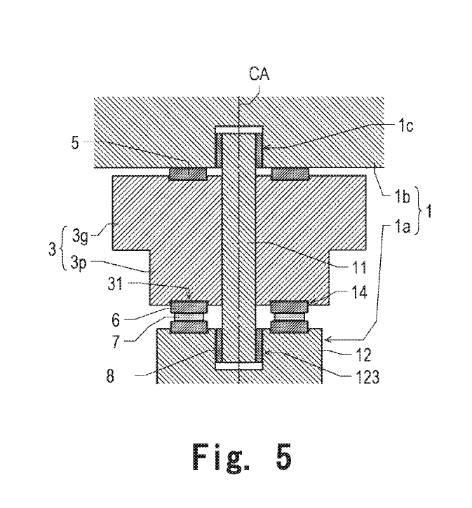

The supporting mechanism of the helical gear body 3 is explained. FIG. 3 is an exploded perspective view for explaining the supporting mechanism of the helical gear body 3. FIG. 4 is a sectional view illustrating an example of the supporting mechanism of the helical gear body 3. FIG. 5 is a sectional view illustrating another example of the supporting mechanism of the helical gear body 3.

The helical gear body 3 has a tubular shape with the center axis CA centered. The helical gears 3g and 3p included in the helical gear body 3 are disposed coaxially and are in an integral structure. Further, the helical gears 3g and 3p included in the helical gear body 3 are capable of rotating around the center axis CA and have the same torsion angle θg=θp. For example, in this embodiment, both of the first helical gear 3g and the second helical gear 3p are disposed on the center axis CA. The first helical gear 3g is disposed on the axially upper side of the second helical gear 3p and is in an integral structure with the second helical gear 3p. The first helical gear 3g and the second helical gear 3p are capable of rotating around the center axis CA and have the same torsion angle θg=θp. That is, the torsion angle θg of a tooth trace 30ga of a tooth 30g of the first helical gear 3g is equal to the torsion angle θp of a tooth trace 30pa of a tooth 30p of the second helical gear 3p. When a torsion angle is increased, a helical gear can transmit larger torque. Therefore, it is possible to transmit maximum torque to other gears meshing with the first helical gear 3g and the second helical gear 3p by setting the torsion angle θg=θp of the first helical gear 3g and the second helical gear 3p largest according to a material in use, the structure of a mold, and the like.

The helical gear body 3 is rotatably supported via a sleeve bearing 8. Therefore, a configuration in which the helical gear body 3 is rotatably supported can be easily assembled and realized at low cost. In this way, the speed reducer 110 further includes the sleeve bearing 8. The sleeve bearing 8 has a tubular shape extending in the axial direction.

More specifically, for example, as illustrated in FIG. 4, the helical gear body 3 is rotatably supported via the sleeve bearing 8 by the rotating shaft section 11 extending from the shaft holding section 12 to the axially upper side. The sleeve bearing 8 is inserted in the tubular helical gear body 3 and provided at the radially inner end portion of the helical gear body 3. The rotating shaft section 11 is inserted in the sleeve bearing 8. The sleeve bearing 8 may be in direct contact with the helical gear body 3 and the rotating shaft section 11 or may be in indirect contact with the helical gear body 3 and the rotating shaft section 11. That is, the radially outer side surface of the sleeve bearing 8 may be in direct contact with the radially inner side surface of the helical gear body 3 or may be in indirect contact with the radially inner side surface of the helical gear body 3 via a lubricating material such as lubricating oil or grease. The radially inner side surface of the sleeve bearing 8 may be in direct contact with the radially outer side surface of the rotating shaft section 11 or may be in indirect contact with the radially outer side surface of the rotating shaft section 11 via a lubricating material such as lubricating oil or grease.

As explained above, in the configuration illustrated in FIG. 4, the helical gear body 3 has the tubular shape with the center axis CA centered. The sleeve bearing 8 is provided at the radially inner end portion of the helical gear body 3. The sleeve bearing 8 is capable of sliding in direct or indirect contact with the helical gear body 3 and the rotating shaft section 11 inserted in the sleeve bearing 8. Therefore, providing the sleeve bearing 8 at the radially inner end portion of the helical gear body 3 makes it possible to secure an area in which the sleeve bearing 8 slides on the rotating shaft section 11. This may increase the durability of the sleeve bearing 8.

Alternatively, for example, as illustrated in FIG. 5, the rotating shaft section 11 attached to the helical gear body 3 may be rotatably supported by the shaft holding section 12 via the tubular sleeve bearing 8 extending in the axial direction. In FIG. 5, the sleeve bearing 8 is provided on the radially inner side surface of an insert-through hole 1c and the radially inner side surface of an insert-through hole 123. The insert-through hole 1c is provided on the lower surface of the upper casing 1b and recessed to the axially upper side. The insert-through hole 123 is provided on the upper surface of the shaft holding section 12 and recessed to the axially lower side. The columnar rotating shaft section 11 extending in the axial direction is inserted in the tubular helical gear body 3. The helical gear body 3 is fixed to the axial-direction center of the rotating shaft section 11 using, for example, an adhesive. Alternatively, the helical gear body 3 and the rotating shaft section 11 may form a part of the same member without being limited to the illustration in FIG. 5. In other words, the helical gear body 3 and the rotating shaft section 11 may be in an integral structure. The axially upper end portion of the rotating shaft section 11 is inserted in the insert-through hole 1c via the sleeve bearing 8. The axially lower end portion of the rotating shaft section 11 is inserted in the insert-through hole 123 via the sleeve bearing 8. In FIG. 5, as in FIG. 4, the sleeve bearing 8 may be in direct contact with the rotating shaft section 11, the inner wall of the insert-through hole 123, and the inner wall of the insert-through hole 1c or may be in indirect contact with the rotating shaft section 11, the inner wall of the insert-through hole 123, and the inner wall of the insert-through hole 1c.

As explained above, in the configuration illustrated in FIG. 5, the insert-through hole 1c recessed in the axial direction is provided in the upper casing 1b. The insert-through hole 123 recessed in the axial direction is provided in the shaft holding section 12. The insert-through hole 123 is provided in the sleeve bearing 8. The sleeve bearing 8 is capable of sliding in direct or indirect contact with the insert-through holes 1c and 123 and the rotating shaft section 11 inserted in the sleeve bearing 8. Therefore, the radial-direction dimension of the helical gear body 3 can be set smaller than that in the configuration illustrated in FIG. 4. Accordingly, it is possible to obtain a larger reduction ratio when the helical gear body 3 meshes with the other gears. It is possible to reduce the number of the teeth 30g and 30p of the helical gear body 3 through the reduction in the radial-direction dimension. Therefore, it is possible to reduce manufacturing cost of the helical gear body 3.

In the supporting structure of the helical gear body 3, a ring-shaped stopper 5 is disposed around the rotating shaft section 11 between the helical gear body 3 and the upper casing 1b. The stopper 5 prevents the helical gear body 3 from coming into contact with the upper casing 1b by moving to the axially upper side. The stopper 5 does not have to be fixed, but may be fixed to, for example, the rotating shaft section 11. If the stopper 5 is fixed, movement of the helical gear body 3 to the axially upper side can be limited by the stopper 5. Alternatively, the stopper 5 may be fixed to the upper surface of the helical gear body 3 and the lower surface of the upper casing 1b.

In the supporting structure of the helical gear body 3, two first washers 6 are disposed around the rotating shaft section 11 between the helical gear body 3 and the shaft holding section 12. One first washer 6 is disposed on the axially upper side of the second washer 7 and attached to the lower surface of the helical gear body 3 as explained below. The other first washer 6 is disposed on the axially lower side of the second washer 7 and attached to the shaft holding section 12 as explained below. The first washers 6 prevent the axially lower end portion of the helical gear body 3 from coming into direct contact with the shaft holding section 12.

The first washer 6 may be disposed on only one of the axial-direction sides of the second washer 7 between the helical gear body 3 and the shaft holding section 12 without being limited to the illustration in FIG. 3. That is, in the axial direction, the first washer 6 may be disposed only between the helical gear body 3 and the second washer 7 or only between the second washer 7 and the shaft holding section 12.

The first washer 6 includes at least one washer contact section 60. The washer contact section 60 is a portion, a radial-direction distance of which from the center axis CA is different depending on a circumferential-direction position, at least at one of the radially inner end portion and the radially outer end portion of the first washer 6. In FIG. 3, the washer contact section 60 is provided at the radially outer end portion of the first washer 6.

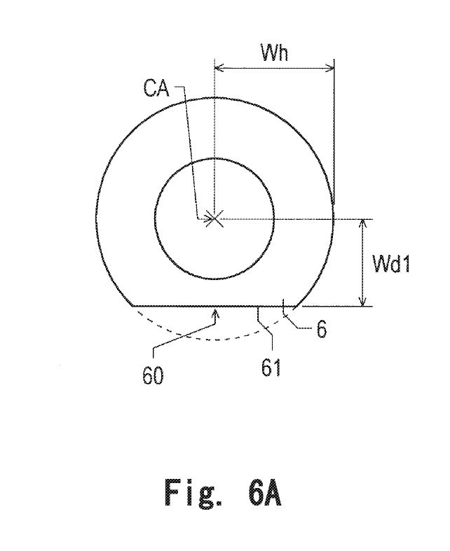

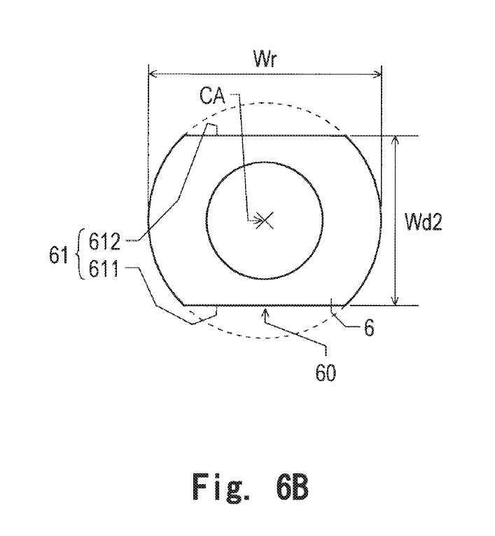

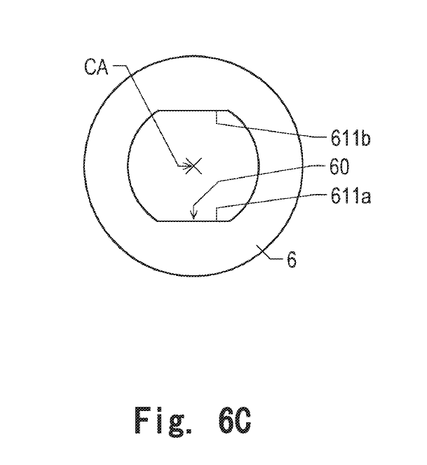

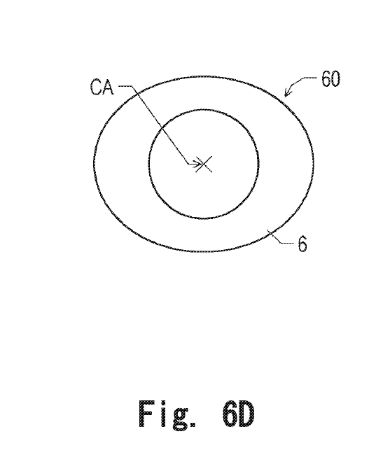

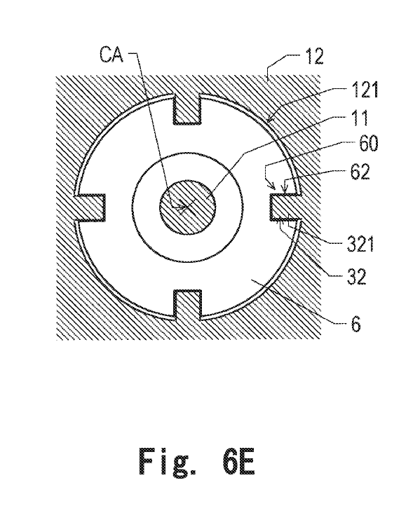

The first washer 6 has a ring shape. The ring shape of the first washer 6 may be an annular shape continuous along the entire circumference in the circumferential direction or may be an annular shape (e.g., an arcuate shape) discontinuous in a part in the circumferential direction. In FIG. 3, a shape illustrated in FIG. 6B explained below is adopted in the first washer 6. The shape of the first washer 6 viewed from the axial direction is explained below.

A fitting recessed section 31 and an opposed section 32 are provided on the lower surface of the helical gear body 3. At least the axially upper end portion of the first washer 6 disposed on top of the second washer 7 in the axial direction is fit in the fitting recessed section 31. In other words, the fitting recessed section 31 in which at least the axial-direction end portion of the first washer 6 is fit is provided on the lower surface of the helical gear body 3 on which an opposed surface 24 is provided. The axial-direction width of the fitting recessed section 31 is desirably equal to or smaller than the axial-direction width of the first washer 6. That is, the depth of the fitting recessed section 31 is desirably equal to or smaller than the thickness of the first washer 6. Consequently, it is possible to further reduce an interval between the helical gear body 3 and the shaft holding section 12 according to the depth of the fitting recessed section 31. Therefore, it is possible to contribute to a reduction in the axial-direction dimension of the speed reducer 110.

The axial-direction width of the fitting recessed section 31 is more desirably equal to or smaller than a half of the axial-direction width of the first washer 6. Consequently, even if the first washer 6 wears in the axial direction, it is easy to maintain a state in which the axially lower end portion of the first washer 6 fit in the fitting recessed section 31 is projected from the axially lower end portion of the helical gear body 3. Therefore, it is easy to secure a gap between the helical gear body 3 and the shaft holding section 12.

At least in the circumferential direction, the opposed section 32 is opposed to the washer contact section 60 of the first washer 6 fit in the fitting recessed section 31. As explained above, in the washer contact section 60, the radial-direction distance from the center axis CA is different depending on a circumferential-direction distance. Therefore, when the first washer 6 rotates in the circumferential direction, the washer contact section 60 is in contact with the opposed section 32 at least in the circumferential direction. Consequently, it is possible to prevent co-rotation of the first washer 6. That is, it is possible to prevent relative rotation of the first washer 6 with respect to the helical gear body 3. The shape and the position of the opposed section 32 are designed according to the shape and the position of the washer contact section 60 opposed to the opposed section 32. For example, in this embodiment, the opposed section 32 is the peripheral edge portion of the fitting recessed section 31, in other words, a step formed by the inner side surface of the fitting recessed section 31 and the lower surface of the helical gear body 3. However, the opposed section 32 is not limited to this illustration. The opposed section 32 may be, for example, a part of a protrusion provided on the lower surface of the helical gear body 3 or a step formed by two lower surfaces in different axial-direction positions.

When the first washer 6 is provided only on the shaft holding section 12 side (i.e., between the second washer 7 and the shaft holding section 12), the fitting recessed section 31 and the opposed section 32 may not be provided on the lower surface of the helical gear body 3.

On the other hand, a fitting recessed section 121 and an opposed section 122 are provided on the upper surface of the shaft holding section 12. At least the axially lower end portion of the first washer 6 disposed under the second washer 7 in the axial direction is fit in the fitting recessed section 121. At least in the circumferential direction, the opposed section 122 is opposed to the washer contact section 60 of the first washer 6 fit in the fitting recessed section 121. When the first washer 6 rotates in the circumferential direction, the washer contact section 60 is in contact with the opposed section 122 in at least the circumferential direction. Consequently, it is possible to prevent co-rotation of the first washer 6. That is, it is possible to prevent relative rotation of the first washer 6 with respect to the shaft holding section 12. The configuration of the opposed section 122 is the same as the configuration of the opposed section 32. The configuration of the fitting recessed section 121 is the same as the fitting recessed section 31. Accordingly, explanation of the configuration of the opposed section 122 and the configuration of the fitting recessed section 121 is omitted.

When the first washer 6 is provided only on the helical gear body 3 side (i.e., between the second washer 7 and the lower surface of the helical gear body 3), the fitting recessed section 121 and the opposed section 122 may not be provided in the shaft holding section 12.

In the supporting structure of the helical gear body 3, besides the two first washers 6, the second washer 7 is disposed around the rotating shaft section 11 between the helical gear body 3 and the shaft holding section 12. In other words, the speed reducer 110 further includes the second washer 7 disposed around the rotating shaft section 11 and in contact with the first washers 6 in the axial direction between the helical gear body 3 and the shaft holding section 12. In this embodiment, the second washer 7 is disposed between the two first washers 6 and prevents direct contact in the axial direction of the two first washers 6. When one first washer 6 is provided between the helical gear body 3 and the shaft holding section 12, the second washer 7 prevents direct contact in the axial direction of the first washer 6 and one of the helical gear body 3 and the shaft holding section 12.

When the helical gear body 3 rotates, the second washer 7 freely rotatable in the circumferential direction slides on the first washer 6, whereby wear of the first washer 6 can be reduced. Like the first washer 6, the second washer 7 may have an annular shape continuous along the entire circumference in the circumferential direction or may have an annular shape discontinuous in a part of the circumferential direction.

When viewed from the axial direction, the entire second washer 7 is desirably located within the area of the first washer 6. With this configuration, when the helical gear body 3 rotates, the entire axial-direction end portion of the second washer 7 in contact with the first washer 6 can be slid on the first washer 6. When the axial-direction width of the first washer 6 is smaller than the axial direction width of the fitting recessed sections 31 and 121 and the first washer 6 is housed in the fitting recessed sections 31 and 121, the second washer 7 can be in contact with the first washer 6 in the fitting recessed sections 31 and 121. For example, when lubricant or the like is filled in the fitting recessed sections 31 and 121, such a configuration is effective to hold the lubricant. However, when viewed from the axial direction, the second washer 7 may at least partially overlap the first washer 6 without being limited to this illustration.

The shape of the first washer 6 is explained with reference to first to fifth examples. In the following explanation, the same components are denoted by the same reference numerals and signs. The above explanation of the components is sometimes omitted.

In the first washer 6 according to the first and second examples, at least one washer contact section 60 is a linear section 61 provided at the radially outer end portion of the first washer 6 and perpendicular to the axial direction when viewed from the axial direction. Co-rotation of the first washer 6 can be prevented by contact of the linear section 61 and the opposed sections 32 and 122.

First, the first example is explained. FIG. 6A is a top view illustrating the first example of the first washer 6. The radially inner end portion of the first washer 6 according to the first example has a circular shape centering on the center axis CA. The radially outer end portion of the first washer 6 is configured by a portion having an arcuate shape and one linear section 61. That is, the first washer 6 according to the first example includes one washer contact section 60 at the radially outer end portion. The washer contact section 60 is the linear section 61. When viewed from the axial direction, the radially outer end portion of the first washer 6 other than the washer contact section 60 has an arcuate shape with a radial-direction radius Wh centering on the center axis CA. When viewed from the axial direction, a shortest radial-direction distance Wd1 between the center position of the first washer 6 and the linear section 61 is desirably 75% to 85% of the radius Wh of the arcuate shape. In the first example, by setting the radial-direction distance Wd1 to 75% to 85% of the radius Wh of the arcuate shape, improvement of an effect of preventing co-rotation of the first washer 6 was successfully confirmed.

The second example is explained. FIG. 6B is a top view illustrating the second example of the first washer 6. The radially inner end portion of the first washer 6 according to the second example has a circular shape centering on the center axis CA. The radially outer end portion of the first washer 6 is configured by a portion having an arcuate shape and the linear section 61. The linear section 61 includes a first linear section 611 and a second linear section 612 parallel to the first linear section 611 when viewed from the axial direction. That is, the first washer 6 according to the second example includes two washer contact sections 60 at the radially outer end portion. One washer contact section 60 is the first linear section 611. The other washer contact section 60 is the second linear section 612. With this shape, the first washer 6 has a so-called both-side D cut shape when viewed from the axial direction. Therefore, in the circumferential direction, opposed portions of the linear section 61 and the opposed sections 32 and 122 can be uniformly disposed, that is, disposed at equal intervals. Accordingly, it is easier to prevent co-rotation of the first washer 6.

When viewed from the axial direction, the radially outer end portion of the first washer 6 other than the two washer contact sections 60 has an arcuate shape with a diameter Wr centering on the center axis CA. When viewed from the axial direction, a shortest radial-direction distance Wd2 between the first linear section 611 and the second linear section 612 is desirably 80% to 90% of the radius Wr of the arcuate shape. In the second example, by setting a so-called two-side width Wd2 between the first linear section 611 and the second linear section 612 to 80% to 90% of the diameter Wr of the arcuate shape, improvement of the effect of preventing co-rotation of the first washer 6 was successfully confirmed. In FIG. 6B, for example, the contact area with the opposed sections 32 and 122 is wider compared with FIG. 6A. Therefore, pressure of the opposed sections 32 and 122 pressing the first washer 6 is reduced. Accordingly, friction of the first washer 6 can also be reduced.

In the third example, two washer contact sections 60 are provided at the radially inner end portion of the first washer 6. FIG. 6C is a top view illustrating the third example of the first washer 6. More specifically, the radially inner end portion of the first washer 6 according to the third example is configured by a portion having an arcuate shape centering on the center axis CA and a pair of parallel linear sections 611a and 612a. That is, the first washer 6 according to the third example includes two washer contact sections 60 at the radially inner end portion. When viewed from the axial direction, the radially inner end portion of the first washer 6 other than the two washer contact sections 60 has an arcuate shape centering on the center axis CA. The radially outer end portion of the first washer 6 has a circular shape centering on the center axis CA. Consequently, co-rotation of the first washer 6 can also be prevented by contact of the washer contact sections 60 and the opposed sections 32 and 122. Since a sliding area of the first washer 6 is relatively large, friction of the first washer 6 can be reduced.

The washer contact sections 60 may be provided at both of the radially inner end portion and the radially outer end portion of the first washer 6 without being limited to the first to third examples.

The first washer 6 may include the washer contact sections 60 in three or more parts. For example, the number of the washer contact sections 60 provided at least at one of the radially outer end portion and the radially outer end portion of the first washer 6 may be three or more. By further increasing the number of the washer contact sections 60 included in the first washer 6, portions where the washer contact sections 60 are in contact with the opposed sections 32 and 122 further increases. Therefore, the effect of preventing co-rotation of the first washer 6 is further improved.

The washer contact section 60 may be other than the linear section 61 without being limited to the first to third examples.

In the fourth example, the entire radially outer end portion of the first washer 6 is the washer contact section 60. FIG. 6D is a top view illustrating the fourth example of the first washer 6. The shape of the radially outer end portion is an elliptical shape, a radial-direction distance of which from the center axis CA is different depending on a circumferential-direction position. Consequently, at least a part of the radially outer end portion of the first washer 6 is in contact with the opposed sections 32 and 122, whereby co-rotation of the first washer 6 can be prevented. Since a change in a sliding area of the first washer 6 in the circumferential direction is relatively gentle, friction of the first washer 6 can be reduced. The entire radially inner end portion of the first washer 6 may be the washer contact section 60 or both of the entire radially inner end portion and the entire radially outer end portion of the first washer 6 may be the washer contact sections 60 without being limited to the fourth example.

In the fifth example, four washer recessed sections 62 recessed to the radially inner side are provided at the radially outer end portion of the first washer 6. FIG. 6E is a top view illustrating the fifth example of the first washer 6. FIG. 6E shows a configuration in which the first washer 6 is fit in the fitting recessed section 31 of the helical gear body 3.

The radially outer end portion of the first washer 6 according to the fifth example is configured by a portion having an arcuate shape centering on the center axis CA and the four washer recessed sections 62. The washer recessed sections 62 are the washer contact sections 60. When viewed from the axial direction, the radially outer end portion of the first washer 6 other than the four washer contact sections 60 has an arcuate shape centering on the center axis CA. In the circumferential direction, the four washer recessed sections 62 are desirably uniformly disposed, that is, disposed at equal intervals. The number of the washer contact sections 60 is four in the fifth example. However, the number of the washer contact sections 60 may be one or may be four or more without being limited to this illustration.

The opposed sections 32 include projecting sections 321 projecting inward in the radial direction and fit in the washer recessed sections 62. Unlike FIG. 6E, when the first washer 6 is fit in the fitting recessed section 121 of the shaft holding section 12, projecting sections projecting inward in the radial direction and fit in the washer recessed sections 62 are provided in the opposed section 122 in the same configuration as the projecting sections 321. The number of the projecting sections 321 is four in FIG. 6E. However, the number of the projecting sections 321 only has to be one or more and equal to or smaller than the number of the washer recessed sections 62 without being limited to this illustration.

In the fifth example, the washer contact sections 60 are configured by only the washer recessed sections 62. However, the first washer 6 is not limited to this illustration. In the first washer 6, the washer contact sections 60 other than the washer recessed sections 62 may be provided. For example, in the first washer 6, besides the washer recessed sections 62, the washer contact section 60 illustrated in at least any one of FIGS. 6A to 6D may be provided. In other words, in the fifth example, at least one washer contact section 60 only has to be the washer recessed section 62 recessed inward in the radial direction at the radially outer end portion of the first washer 6. The opposed section 32 includes the projecting section 321 fit in the washer recessed section 62. Consequently, the projecting section 321 is fit in the washer recessed section 62, whereby the effect of preventing co-rotation of the first washer 6 is further improved.

The washer recessed sections 62 are provided at equal intervals in the circumferential direction. Consequently, structures in which the projecting sections 321 are fit in the washer recessed sections 62 are uniformly disposed in the circumferential direction of the first washer 6. Therefore, co-rotation of the first washer 6 can be prevented without deviation in the circumferential direction.

As explained above, the speed reducer 110 in this embodiment transmits the torque of the motor 120 to the output shaft 111. The speed reducer 110 includes the helical gear body 3 including the helical gears 3g and 3p that have the different diameters and are in the integral structure, the rotating shaft section 11 that extends in the up-down direction of the center axis CA and supports the helical gear body 3, the shaft holding section 12 that holds the rotating shaft section 11, and the first washer 6 disposed around the rotating shaft section 11 between the helical gear body 3 and the shaft holding section 12. The helical gears 3g and 3p are disposed coaxially, are capable of rotating around the center axis CA, and have the same torsion angle θg=θp. The shaft holding section 12 is opposed to the axial-direction end portion of the helical gear body 3 via the first washer 6 in the axial direction. At least one of the radially inner end portion and the radially outer end portion of the first washer 6 includes the washer contact section 60, the radial-direction distance of which from the center axis CA is different depending on the circumferential-direction position. One of the axial-direction end portion of the helical gear body 3 and the shaft holding section 12 includes the opposed section 32. The opposed section 32 is opposed to the washer contact section 60 in at least the circumferential direction.

With these configurations, in the helical gear body 3, the helical gears 3g and 3p having the different diameters are in the integral structure and have the same torsion angle θg=θp. When the torsion angle is increased, the helical gears can transmit larger torque. Therefore, by setting the torsion angle θg=θp of the helical gears 3g and 3p largest according to a material in use, the structure of a mold, and the like, the helical gears 3g and 3p can transmit maximum torque to the other gears with which the helical gears 3g and 3p mesh.

When the radially outer diameter of one gear 3g of the helical gears 3g and 3p having the different diameters is larger than the radially outer diameter of the other gear 3p, a force in the axial direction corresponding to the torsion angles θg and θp and the radially outer diameters acts when the gears 3g and 3p mesh with each other and transmit torque. With the force in the axial direction, the axial-direction end portion of the helical gear body 3 slides while being pressed by the shaft holding section 12 and the like opposed to the axial-direction end portion. In the configuration explained above, the first washer 6 is provided between the helical gear body 3 and the shaft holding section 12 in order to reduce friction at the axial-direction end portion of the helical gear body 3 due to such sliding. Further, the washer contact section 60 and the opposed sections 32 and 122 are in contact at least in the circumferential direction, whereby co-rotation of the first washer 6 is prevented. The co-rotation of the first washer 6 indicates that the first washer 6 relatively rotates with respect to one (i.e., one including the opposed sections 32 and 122) of the axial-direction end portion of the helical gear body 3 and the shaft holding section 12. Therefore, it is possible to prevent, with the first washer 6, one of the axial-direction end portion of the helical gear body 3 and the shaft holding section 12 from sliding directly on the other. Further, according to the prevention of the co-rotation of the first washer 6, it is possible to prevent sliding of one (i.e., one including the opposed sections 32 and 122) of the axial-direction end portion of the helical gear body 3 and the shaft holding section 12 and the first washer 6 and prevent wear of the one of the axial-direction end portion of the helical gear body 3 and the shaft holding section 12. Therefore, it is possible to prevent wear of the end face of the helical gear body 3.

The present disclosure is useful in, for example, an apparatus including the helical gear body 3 in which the first helical gear 3g and the second helical gear 3p are provided in the integral structure.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A speed reducer that transmits torque of a motor to an output shaft, the speed reducer comprising:
a helical gear body including a plurality of helical gears that have different diameters and are in an integral structure;
a rotating shaft that extends in an up-down direction of a center axis and supports the helical gear body;
a shaft holder that holds the rotating shaft; and
a first washer disposed around the rotating shaft between the helical gear body and the shaft holder; wherein
the plurality of helical gears are disposed coaxially, are capable of rotating around the center axis, and have a same torsion angle;
the shaft holder is opposed to an axial-direction end portion of the helical gear body in an axial direction via the first washer;
at least one of a radially inner end portion and a radially outer end portion of the first washer includes a washer contact surface, a radial-direction distance of which from the center axis is different depending on a circumferential-direction position;
one of the axial-direction end portion of the helical gear body and the shaft holder includes an opposed surface; and
the opposed surface is opposed to the washer contact surface at least in a circumferential direction.

2. The speed reducer according to claim 1, wherein the helical gear body is rotatably supported via a sleeve bearing.

3. The speed reducer according to claim 2, wherein
the helical gear body has a tubular shape with the center axis centered; and
the sleeve bearing is provided at a radially inner end portion of the helical gear body and is capable of sliding in direct or indirect contact with the helical gear body and the rotating shaft inserted in the sleeve bearing.

4. The speed reducer according to claim 2, wherein
an insert-through hole recessed in the axial direction is provided in the shaft holder; and
the sleeve bearing is provided in the insert-through hole and is capable of sliding in direct or indirect contact with the insert-through hole and the rotating shaft inserted in the sleeve bearing.

5. The speed reducer according to claim 1, wherein the washer contact surface includes a linear section provided at the radially outer end portion of the first washer and perpendicular to the axial direction when viewed from the axial direction.

6. The speed reducer according to claim 5, wherein
the radially outer end portion of the first washer other than the washer contact surface has an arcuate shape with the center axis centered; and
when viewed from the axial direction, a shortest radial-direction distance between a center position of the first washer and the linear section is 75% to 85% of a radius of the arcuate shape.

7. The speed reducer according to claim 5, wherein the linear section includes a first linear section and a second linear section parallel or substantially parallel to the first linear section when viewed from the axial direction.

8. The speed reducer according to claim 7, wherein
the radially outer end portion of the first washer other than the washer contact surface has an arcuate shape with the center axis centered; and
when viewed from the axial direction, a shortest radial-direction distance between the first linear section and the second linear section is 80% to 90% of a diameter of the arcuate shape.

9. The speed reducer according to claim 1, wherein the first washer includes at least three washer contact surfaces.

10. The speed reducer according to claim 1, wherein
the washer contact surface includes a washer recessed section recessed inward in a radial direction at the radially outer end portion of the first washer; and
the opposed surface includes a projecting section fit in the washer recessed surface.

11. The speed reducer according to claim 10, wherein a plurality of the washer recessed sections are provided at equal or substantially equal intervals in the circumferential direction.

12. The speed reducer according to claim 1, wherein
a fitting recessed section in which at least an axial-direction end portion of the first washer is fit is provided on a surface on which the opposed surface is provided; and
an axial-direction width of the fitting recessed section is equal to or smaller than an axial-direction width of the first washer.

13. The speed reducer according to claim 12, wherein an axial-direction length of the fitting recessed section is equal to or smaller than a half of the axial-direction width of the first washer.

14. The speed reducer according to claim 1, further comprising a second washer disposed around the rotating shaft and being in contact with the first washer in the axial direction between the helical gear body and the shaft holder.

15. The speed reducer according to claim 14, wherein, when viewed from the axial direction, an entirety of the second washer is located within the area of the first washer.

16. The speed reducer according to claim 1, further comprising a first transmission gear and a second transmission gear; wherein
the plurality of helical gears include a first helical gear and a second helical gear;
the first transmission gear is opposed to and meshes with the first helical gear in a radial direction, and transmits torque from the motor to the first helical gear; and
the second transmission gear is opposed to and meshes with the second helical gear in the radial direction, and transmits torque from the second helical gear to the output shaft.

17. The speed reducer according to claim 16, wherein, when viewed from the axial direction, the first transmission gear at least partially overlaps the motor.

18. A motor unit comprising:
a motor; and
the speed reducer according to claim 1, wherein
the speed reducer is attached to the motor and transmits torque of the motor to the output shaft.

19. A cleaning robot comprising the motor unit according to claim 18.
